(19) United States
(12) Patent Application Publication
(10) Pub. No.: US 2008/0151844 A1
(43) Pub. Date: Jun. 26, 2008

(54) Wireless access point authentication system and method

(76) Inventor: Manish Tiwari, Dublin, CA (US)

Correspondence Address: PERKINS COIE LLP, P.O. BOX 2168, MENLO PARK, CA, 94026, US

(21) Appl. No.: 11/643,329

(22) Filed: Dec. 20, 2006

(51) Int. Cl. H04Q 7/24

(52) U.S. Cl. 370/338

(57) ABSTRACT

A technique for addressing access point (AP) authentication issues involves providing AP fingerprinting. With AP fingerprinting, it becomes relatively difficult to spoof a basic service set ID (bssid) in a domain. Advantageously, wired connectivity is not required for AP authentication when an AP fingerprint is used. In a specific implementation, 802.11 management packets are used to communicate network identity and authentication information for APs.

### BACKGROUND

An access point (AP) is a device used by wireless clients to connect to a network. An AP functions as a standalone entity in some implementations and functions in cooperation with distribution hardware in other implementations. Distribution hardware may include a wireless switch used to manage APs and provide network-connectivity to wireless clients. A wireless domain may refer to a group of wireless switches that are configured to exchange relevant information, and using this information make informed decisions. A known device is a station (e.g., a wireless AP or client device) that is part of a network wireless installation. A rogue device is a station that is considered harmful for a network wireless installation because it is, for example, violating policies or hampering wireless access to the network.

Rogues make it risky to share information among APs of a domain over the air. To date, efforts to detect rogue devices include assuming that any unknown basic service set ID (bssid) is that of a rogue. Since bssids can be spoofed, it is dangerous to do otherwise. It would be advantageous if there was a way to ensure with reasonable certainty that an AP is not a rogue. Any other improvements to rogue detection and/or AP authentication would be valuable, as well.

These are but a subset of the problems and issues associated with wireless access point authentication, and are intended to characterize weaknesses in the prior art by way of example. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for addressing access point (AP) authentication issues involves providing AP fingerprinting. With AP fingerprinting, it becomes relatively difficult to spoof a basic service set ID (bssid) in a domain. Advantageously, wired connectivity is not required for AP authentication when an AP fingerprint is used. In a specific implementation, 802.11 management packets are used to communicate network identity and authentication information for APs. The implementation may facilitate authentication via a replay-immune mechanism.

An example of AP fingerprinting involves a shared secret split between distribution hardware and an AP that enables encryption of identity information over the air. As another example, beacons may be statistically sampled for authenticity (i.e., per packet verification).

The proposed system can offer, among other advantages, improved wireless AP authentication. This and other advantages of the techniques described herein will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts an example of a wireless domain that includes a rogue detection engine that does not rely upon wired connectivity to detect a rogue.

FIG. 2 depicts an example of a system for initializing an AP for authentication at a wireless switch.

FIG. 3 depicts an example of a system for providing a bssid and fingerprint from a first AP to a second AP of a wireless domain.

FIG. 4 depicts an example of a system for authenticating a wireless station at an AP.

FIGS. 5A and 5B depict a flowchart of an example of a method for authenticating a station at an AP.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

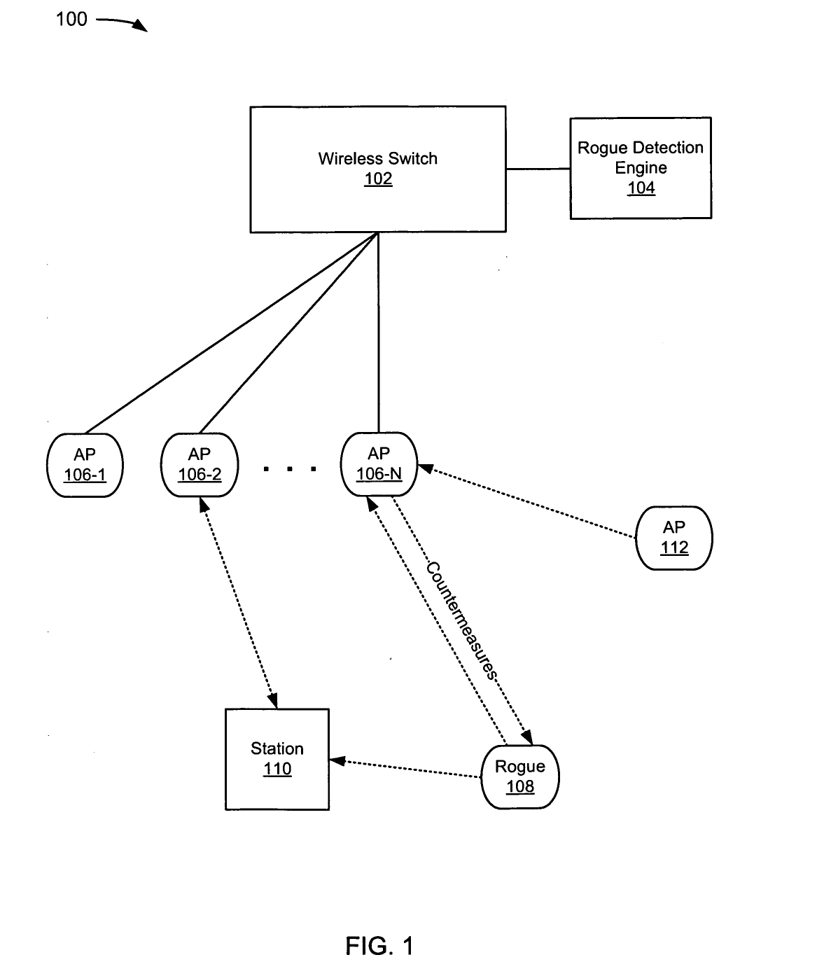

FIG. 1 depicts an example of a wireless domain 100 that includes a rogue detection engine that does not rely upon wired connectivity to detect a rogue. The wireless domain 100 may include, by way of example but not limitation, a Trapeze Networks, Inc. MOBILITY DOMAIN™ wireless domain. The wireless domain 100 includes a wireless switch 102, a rogue detection engine 104, and one or more access points (APs) 106-1 to 106-N (referred to collectively as APs 106).

The wireless switch 102 may include, by way of example but not limitation, a Trapeze Networks, Inc. MOBILITY EXCHANGE™ (or MX®) switch. However, any applicable known or convenient switch that is capable of coupling APs of a wireless network together could be used. In addition, some technologies may have APs that include switch functionality, and since they incorporate the switch functionality, obviate provisioning a distinct switch. In the example of FIG. 1, the switch 102 is not depicted as being coupled to, e.g., a wired backbone because FIG. 1 is in part intended to illustrate how the rogue detection engine 104 does not require wired connectivity to detect a rogue. However, it should be noted that in most implementations, the switch 102 will be coupled to a wired backbone, though wired connectivity may be briefly interrupted, either for the switch 102 or for some other device with which the switch 102 communicates (such as other switches associated with the wireless domain 100 or neighboring wireless domains), for various reasons, including damage to the hardware, taking switches or other distribution hardware offline, etc.

In an illustrative embodiment, the rogue detection engine 104 is embodied in a computer-readable medium. The computer-readable medium may or may not be part of the switch 102. In any case, as would be known to one of ordinary skill in the computer arts, a processor would be used to run executable code on the computer-readable medium or to access data and/or executable code on the computer-readable medium. The rogue detection engine 104 is useful primarily to detect rogues that are acting like APs, but could be used to detect rogues that are acting as any type of station, depending upon the implementation, station characteristics or behavior, and/or configuration.

The APs 106 may include, by way of example but not limitation, Trapeze Networks, Inc. MOBILITY POINT™ (or MP®) APs. However, any applicable known or convenient AP that is capable of coupling a wireless device (or station) to the switch 102 could be used. It may be noted that a station could include an AP. A wireless AP that is coupled to the switch 102 through one of the APs 106 may be referred to as an untethered AP.

It should be noted that not all technologies include the term AP in the literature. For example, SGSN technology does not refer to an access point as an “AP.” However, all wireless access technologies require something comparable (i.e., a node at which wireless communications are received and/or transmitted). For example, an independent basic service set (BSS) includes stations that access the service area by directly communicating with one another; thus, the access nodes are the stations themselves. Accordingly, AP is considered to be generally applicable to any technology, regardless of actual verbiage used to describe a BSS with equivalent functionality.

In the example of FIG. 1, each of the APs 106 may be associated with a BSS. Together, the APs may be associated with an extended service set (ESS). In an embodiment, the wireless domain 100 includes the ESS. In such an embodiment, all of the APs 106, because they are part of the ESS, would likely have the same service set identifier (ssid), which serves as a network “name.” In addition, each of the APs 106 would likely have a unique BSS identifier (bssid). Although this is common for networks that include an ESS, literature may refer to equivalent identifiers in alternative network implementations or when using different technologies using different terminology. Applicable techniques described herein would still apply.

In the example of FIG. 1, a rogue 108, a station 110, and an AP 112 are depicted for illustrative purposes. The rogue 108 acts like an AP in order to, for example, acquire information from the station 110 or the wireless switch 102 by tricking the station 110 or the wireless switch 102 into believing the rogue 108 is one of the APs 106. For example, the rogue 108 may masquerade the media access control (MAC) address of one of the APs 106, then send an alarm for it. In operation, the rogue detection engine 104 can detect the rogue 108. When the rogue 108 is detected, countermeasures are enacted, as conceptually depicted in FIG. 1 as the dashed arrow from the AP 106-N to the rogue 108. Any known or convenient technique for dealing with a detected rogue can be used, and the countermeasures may or may not include transmissions directed at the rogue 108 as depicted, for conceptual purposes, in the example of FIG. 1.

In the example of FIG. 1, the station 110 is associated with the AP 106-2. If the rogue 108 masquerades the MAC address of the AP 106-2, the station 110 may (if not counteracted) be tricked into sending packets to the rogue 108. If countermeasures are implemented rapidly enough, a station 110 should not be compromised. It may be noted that the countermeasures are depicted in FIG. 1 as extending from the AP 106-N to the rogue 108. However, countermeasures could also be sent through the AP 106-2 to the station 110 and then, potentially, to the rogue 108. Alternatively, countermeasures could be entirely internal, where nothing is sent to the rogue 108, but the station 110 is alerted regarding the rogue 108 in such a way that the station 110 will not attempt authentication with the rogue 108.

The station 110 may be practically any known or convenient device that is capable of communicating with a wireless network, such as, by way of example but not limitation, a pda, cell phone, laptop, or untethered AP. A station, as used herein, may be referred to as a device with a MAC address and a physical layer (PHY) interface to the wireless medium that comply with the IEEE 802.11 standard, or some other known or convenient standard, such as IEEE 802.15 or a proprietary wireless standard. Similarly, in some embodiments, the APs 106 and/or the rogue 108 are, at least technically, stations.

It may be noted that the wireless domain 100 is depicted as self-contained. This is to illustrate that, in an embodiment, the rogue AP detection engine 104 can detect APs in the wireless domain 100 without relying upon wired connectivity. Advantageously, this facilitates preventing false positives in case of lost wired connectivity. For example, if the AP 112 is part of the same wireless domain as the APs 106, but the AP 112 is wire connected to a switch (not shown) with which the wireless switch 102 has lost wired connectivity, the AP 112 can still be properly identified as a non-threat. This functionality can also be extended to share information among the APs 106 over the air in a secure manner.

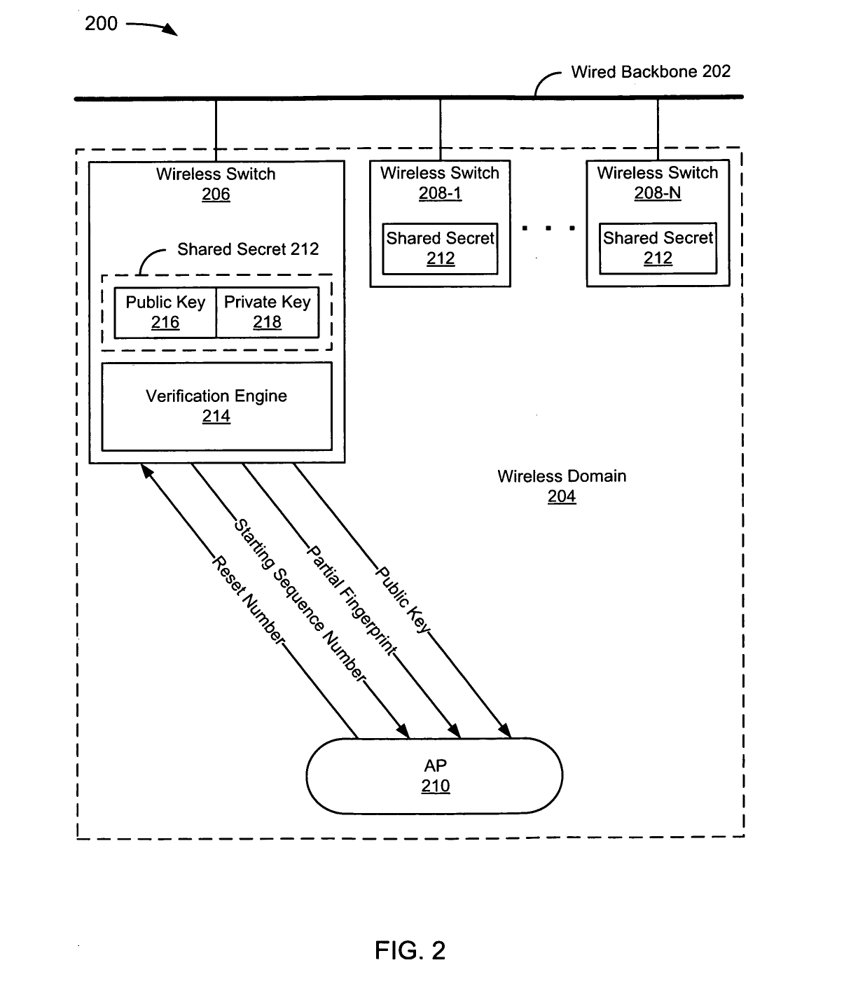

FIG. 2 depicts an example of a system 200 for initializing an AP for authentication at a wireless switch. The system 200 includes a wired backbone 202 and a wireless domain 204. The wireless backbone 202 is typically coupled indirectly (through a LAN, WAN, or some other network) or directly to the Internet. The wireless domain 204 may include, in some embodiments, an ESS. In the example of FIG. 2, the wireless domain 204 includes a wireless switch 206, wireless switches 208-1 to 208-N (referred to collectively as wireless switches 206), and an AP 210.

The wireless switch 206 includes a shared secret 212 and a verification engine 214, one or both of which may be embodied in a computer-readable medium at the wireless switch 206. The shared secret 212 is referred to as “shared” because it is provided to the wireless switches 208 (and/or to other applicable distribution hardware components). In the absence of an explicitly configured shared secret 212, for example, a wireless domain seed IP address can be used. In an alternative embodiment, the shared secret 212 could be expressly configured on the wireless switches 206, 208 by a known or convenient admin procedure (which may or may not include human interaction), or, in another alternative embodiment, provided wirelessly through trusted APs.

The shared secret 212 includes a public key 216 and a private key 218. The public key 216 is, as will be described later, sent wirelessly in, by way of example but not limitation, beacon frames, to any station that can hear the broadcast; hence the name “public” key. However, in the example of FIG. 2, the AP 210 is assumed to be coupled to the wireless switch 206 through a wired connection. In an alternative embodiment, the AP 210 may be coupled to the switch 206 via a wireless connection. The private key 218 is, in an illustrative embodiment, never (intentionally) broadcast over the air.

The public and private key nomenclature is not intended to limit the nature or structure of the shared secret. Herein, the shared secret 212 may be referred to as the value ‘T’, the public key as the value ‘T1’, and the private key as the value ‘T2’, where the values are any applicable strings of characters or other indicia used in the manner described herein, or in an applicable known or convenient manner. Thus, T1 and T2 comprise T. For example, a first portion of T may include T1 and a second portion of T may include T2. Alternatively, T1 and T2 are derivable from T in some other manner. Thus, if T is known, T1 and T2 are known or can be derived from T.

In an illustrative embodiment, the AP 210 is wire connected to the wireless switch 206. The AP 210 may send data (not shown) for verification at the wireless switch 206 by the verification engine 214. In an illustrative embodiment, the verification engine 214 is capable of computing fingerprints and otherwise verifying data associated with the AP 210 and other stations. The functionality of the verification engine 214 should become clear from the descriptions below regarding verification procedures carried out at the switch 206, or an equivalent device.

In the example of FIG. 2, in operation, the AP 210 sends a reset number to the wireless switch 206. In an illustrative embodiment, the AP 210 sends the reset number in one or more “announce packets.” The transmission of the reset number may be part of an initialization procedure that establishes or re-establishes (after a reset) the AP 210 as a part of the wireless domain 204. The reset number may be represented as R[x], where R[x] is one of a sequence of, e.g., monotonically increasing values, R[0], R[1], . . . R[x], R[y], . . . , R[n] that denote the reset count of the AP 210. In an illustrative embodiment, at any given time during which the AP 210 is operational on the wireless domain 204 (and at other specific times, such as during reset), the AP 210 embodies the most recent value R[x] in a computer-readable medium. It may be advantageous for the computer-readable medium to be non-volatile so that when the AP 210 is reset, R[x] is not lost. After a reset, the AP 210 increments R[x] to get R[y], which may or may not be the same as R[x+1], depending upon the implementation. The AP 210 may also inform the wireless switch 206 about its current value of R[x].

In the example of FIG. 2, in operation, the wireless switch 206 sends to the AP 210 with three distinct values: a starting sequence number, a partial fingerprint, and the public key 218. The starting sequence number may be represented as S[0], where S[0] is the first of a sequence of values, S[0], S[1], . . . , S[j], S[k], . . . , S[n] having by way of example but not limitation the following characteristics: 1) the wireless switch 206 and/or the AP 210 can easily compute the value of S[0] given S[k], 2) the AP 210 can easily compute S[k] given S[j], and 3) the AP 210 can easily compute k given the value of S[k] and S[0]. In this document, S[0] may be referred to as a starting sequence number, S[k] may be referred as sequence number, and S[j] may be referred to as the preceding sequence number. A new S[0] may be generated for each iteration of an exchange.

In the example of FIG. 2, the wireless switch 206 sends a partial fingerprint to the AP 210. In an illustrative embodiment, the verification engine 214 uses the reset number received from the AP 210, the sequence number that the wireless switch 206 sends to the AP 210, and the private key 218 to calculate the partial fingerprint. The partial fingerprint may be represented as a function, f( ), of the values used to compute the partial fingerprint, f(S[0], R[x], T2). In an illustrative embodiment, f( ) is a one-way hash function that is difficult to reverse engineer in a reasonable time even after a large sample size for the output of f( ) is made available. Computing f( ) is also computationally intensive so that this computation cannot reasonably be expected to be performed on a per-packet basis. FIG. 2 is intended to illustrate an initialization framework that will facilitate wireless access point authentication.

In the example of FIG. 2, the wireless switch 206 sends the public key 218 to the AP 210. Notably, while the public key 218 could be sent in the clear, the private key 216 is used to encrypt the partial fingerprint and is, therefore, not sent in the clear. Although the partial fingerprint, the starting sequence number, and the public key 218 appear, in the example of FIG. 2, to be sent in three transactions, the values may or may not be sent in a single frame or packet.

As will be described later, the values sent from the wireless switch 206 are used to compute, e.g., a fingerprint at the AP 210. Accordingly, it may be advantageous to store the values in run-time memory to facilitate faster fingerprint computation. However, this would be an implementation-specific decision.

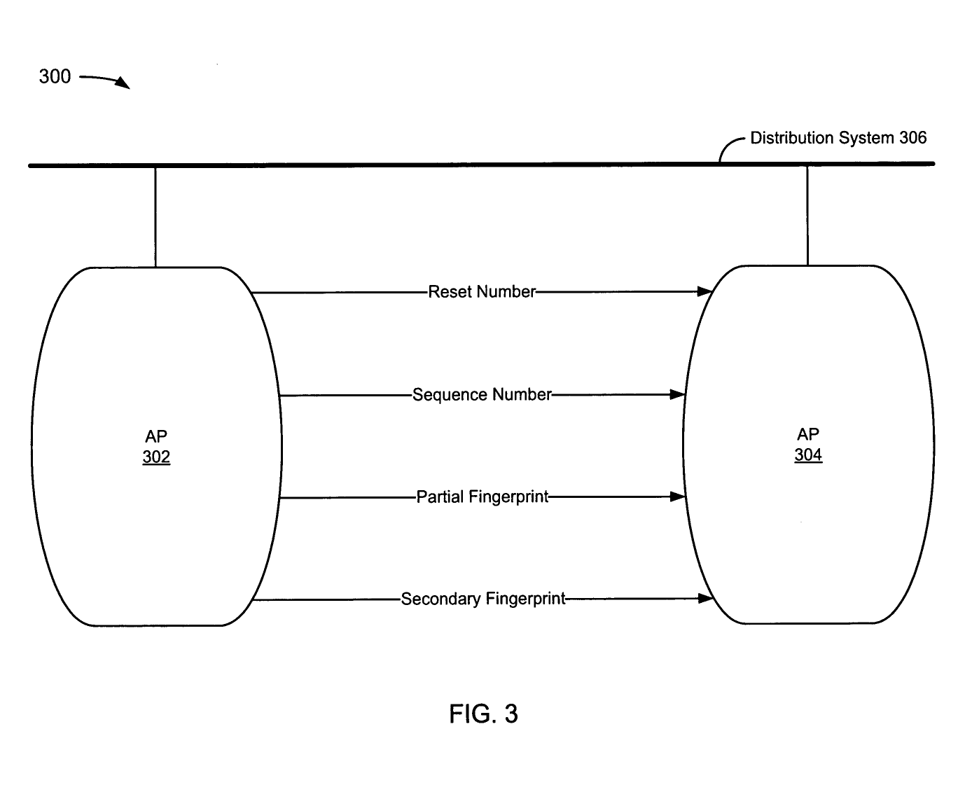

FIG. 3 depicts an example of a system 300 for providing a bssid and fingerprint from a first AP to a second AP of a wireless domain. The following description of the example of FIG. 3 may make use of components described by way of example but not limitation with reference to FIG. 2. It may be noted that any applicable known or convenient alternatives may be used without deviating from one or more of the techniques described herein.

In the example of FIG. 3, the system 300 includes a first AP 302 and a second AP 304, both of which are coupled to a distribution system 306. For illustrative simplicity, the AP 302 and the AP 304 are assumed to be initialized and operational in a wireless domain. Other optional components of the system 300 (e.g., wireless switches that may or may not be a part of the distribution system 306, additional APs, a wired backbone that may or may not be coupled to the distribution system 306, etc.) are omitted for the sake of simplicity.

In the example of FIG. 3, the AP 302 transmits (e.g., broadcasts), by way of example but not limitation, a beacon frame, including a fingerprint, which is received the AP 304. It should be noted that the intended recipient of a beacon frame from the AP 302 is not necessarily the AP 304. Indeed, reception at the AP 304, while unavoidable in some implementations, may be considered a nuisance. Advantageously, the nuisance effect is reduced or eliminated using techniques described herein. It may be noted that, in addition to or instead of a beacon frame, the AP 302 could send by any applicable known or convenient means (e.g., in a packet, frame, or other structure capable of including a proprietary TLV). Although it may be possible to target stations without incidentally targeting the AP 304 with, e.g., unicast or multicast messages, and still make use of techniques described herein, the primary purpose of the example of FIG. 3 is to illustrate how to treat broadcast messages that are incidentally, rather than intentionally, received at the AP 304.

In the example of FIG. 3, the AP 302 broadcasts a reset number, a sequence number, a partial fingerprint, and a secondary fingerprint, all of which, together, may be referred to as a primary fingerprint or simply the fingerprint. While each of the values associated with the fingerprint is represented as a distinct transaction in the example of FIG. 3, it should be understood that the values may or may not be combined into a single frame or packet, such as a beacon frame. Using the nomenclature described with reference to FIG. 2, the reset number may be represented as R[x] and the partial fingerprint as f(S[0], R[x], T2).

In the example of FIG. 3, the sequence number may be different from the starting sequence number received at the AP 302 upon initialization of the AP 302 by the distribution system 306 (see, e.g., FIG. 2). Using the nomenclature introduced with reference to FIG. 2, the starting sequence number (of FIG. 2) may be represented as S[0], and the sequence number (of FIG. 3) may be represented as S[k].

In an illustrative embodiment, the secondary fingerprint broadcast by the AP 302 is encrypted using the private key, along with other values that are sent together with the secondary fingerprint. The secondary fingerprint may be represented as a function, h( ). In an illustrative embodiment, using the nomenclature introduced with reference to FIG. 2, the secondary fingerprint may be represented as h(S[k], R[x], f(S[0], R[x], T2), T1). Examples of many of the values used to compute the secondary fingerprint (e.g., R[x], S[k], and f(S[0], R[x], T2)) are described above with reference to FIG. 2.

In an illustrative embodiment, h(a, b, c) is a one-way hash function that is difficult to reverse engineer in a reasonable time, but it is computationally simple to compute h( ) on a per packet basis. It may be noted that in the example of FIG. 3, h( ) is essentially computed on T1 and everything else that is present in the fingerprint. S[k] changes with every packet and hence h( ) is different for every packet. The AP 302 starts with a new S[1] when it receives a new S[0] from the distribution system 306, after a reset. In an embodiment, a new S[1] is always accompanied by an increased value of R[x]. For security purposes, S[0] is never sent on the air. (Of course, it is possible, albeit possibly unnecessary and possibly insecure, to send S[0] over the air.)

In an illustrative embodiment, the fingerprint provided from the first AP 302 to the second AP 304 is known to both. This is because each of the APs of a wireless domain are provided the values used to compute the fingerprint by, e.g., a switch upon initialization of the APs into the wireless domain (see, e.g., FIG. 2). Advantageously, since the fingerprint included in the beacon (or other structure) sent by the AP 302 is known, the AP 304 can relatively easily identify the AP 302 as a station that is not a threat. In other words, for systems constructed according to this technique, the presence of a fingerprint in a frame from the AP 302, and the ability of the AP 304 to verify the fingerprint (either at the AP 304 or further up in the distribution system 306), at least to some extent guarantees knowledge of a shared secret, and hence membership in the wireless domain can be confirmed. Accordingly, the use of resource-intensive threat-detection techniques is obviated for APs of the same wireless domain.

Not all beacons or other frames will necessarily come from other APs in the wireless domain. Although this technique helps to ensure that resources are conserved by avoiding incorrectly classifying other APs of the domain as threats, some threats are real. For illustrative purposes, such threats are presumed to come from a rogue device (though, conceivably, threats could be inadvertent, from interfering devices other than other APs in the same wireless domain).

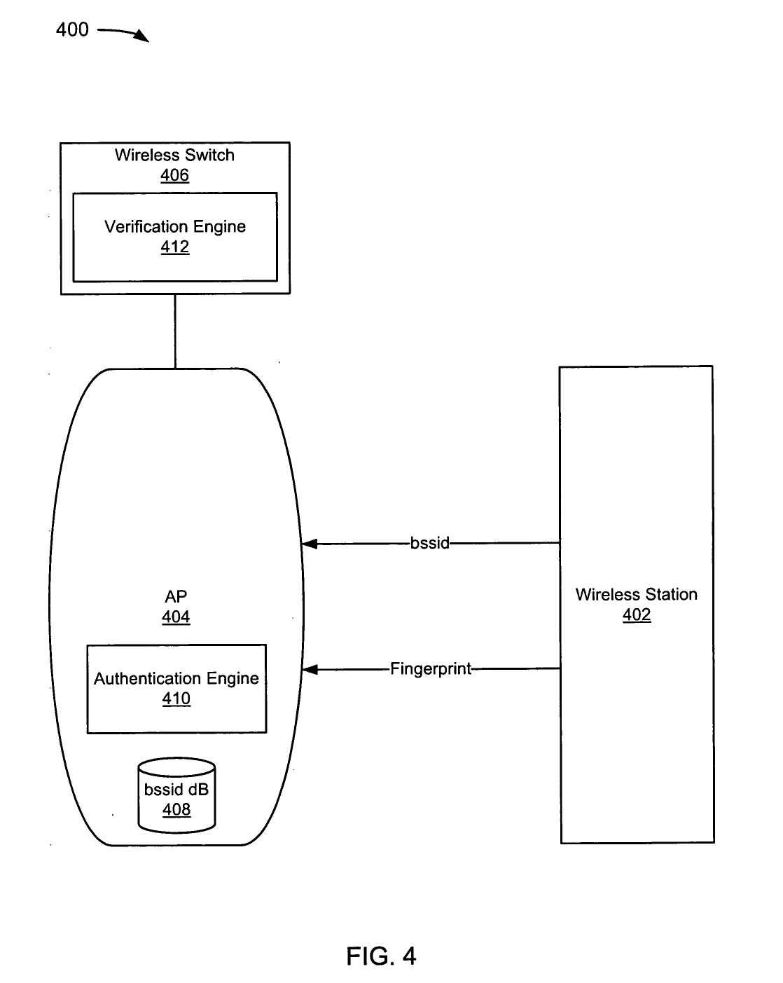

FIG. 4 depicts an example of a system 400 for authenticating a wireless station at an AP. It may be noted that APs are one example of a wireless station. Thus, the wireless station of FIG. 4 could be an AP. In the example of FIG. 4, the system 400 includes a wireless station 402, an AP 404, and a wireless switch 406 (other components are omitted for the sake of illustrative simplicity). In the example of FIG. 4, the wireless station 402 sends message, such as by way of example but not limitation a beacon frame, including a bssid and a fingerprint, to the AP 404. It may be noted that, in addition to or instead of a beacon frame, the wireless station 402 could send the bssid by any applicable known or convenient means (e.g., in a packet, frame, or other structure or structures capable of including a bssid and a fingerprint).

In the example of FIG. 4, the AP 404 includes a bssid database 408 and an authentication engine 410. In operation, in an illustrative embodiment, the bssid database 408 includes a plurality of records of bssids. In an illustrative embodiment, records of the detected bssid database 408 include a bssid field, a reset number field, a fingerprint field, an AP ID flag, and a spoof flag. In an alternative, the bssids and associated data, if any, are stored in some other known or convenient manner.

The AP ID flag is a conceptual tool that may or may not actually be implemented in fact in an embodiment that includes equivalent functionality. As used herein, the AP ID flag indicates that the AP uses the bssid in question. Depending upon the implementation, the AP may use multiple bssids. Since bssids are unique, a message received from some other device that includes a bssid used by the receiving AP is suspicious at least.

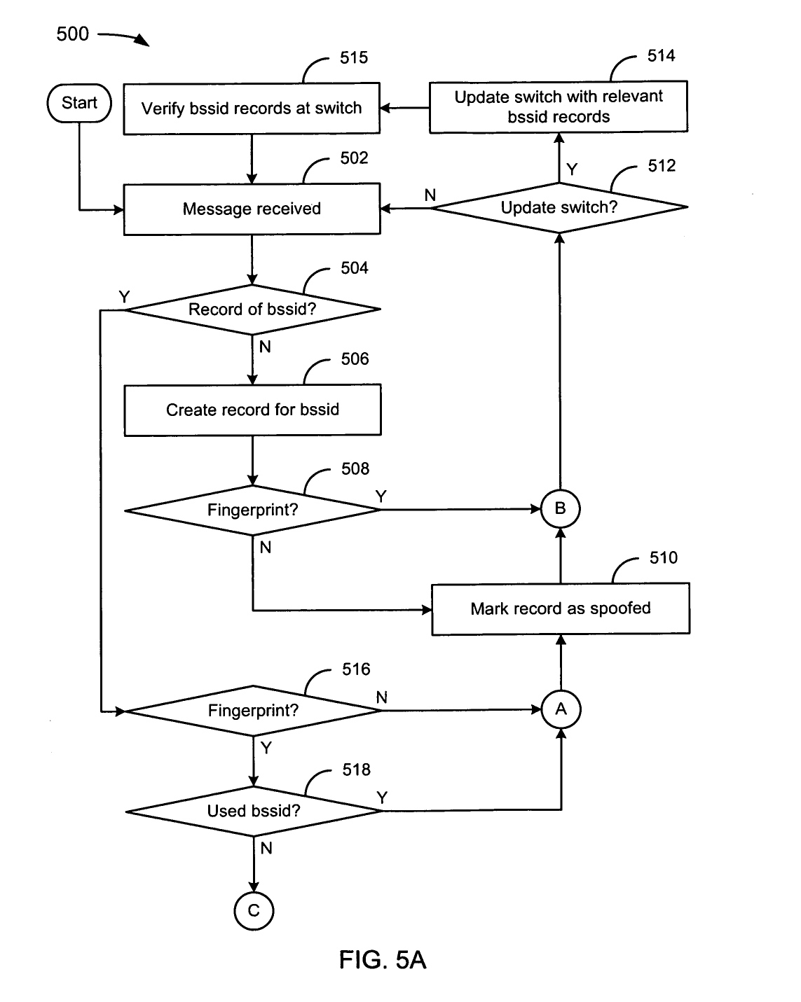

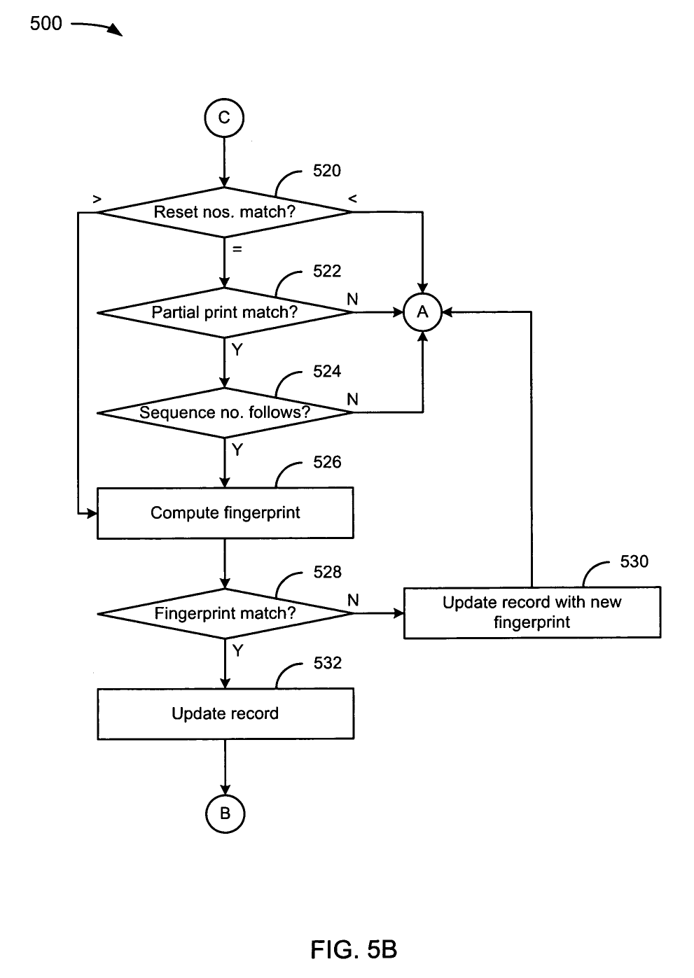

In the example of FIG. 4, in operation, when the AP 404 receives a bssid from the wireless station 402, the authentication engine 410 performs one or more bssid database 408 accesses and comparisons, in accordance with an authentication algorithm embodied in a computer-readable medium in association with the authentication engine 410, that culminate in authentication (or not) of the wireless station 402. An example of such an algorithm is described with reference to FIGS. 5A and 5B.

In the example of FIG. 4, in operation, the AP 404 occasionally updates the wireless switch 406 with entries of the bssid database 408. The AP 404 may periodically update the wireless switch 406 with each entry, or the entries may be marked as spoofed and/or dirty (i.e., changed since the last update to the wireless switch 406), and only those entries that are marked spoofed and/or dirty are updated to the switch 406. The verification engine 412 then verifies that the entries are valid or invalid, and informs the AP 404. For invalid entries, the verification engine 412 may stimulate countermeasures against a rogue or interfering device. The countermeasures engine (not shown) may be embodied in a computer-readable medium at the wireless switch 406, partially embodied there, or located higher up in the distribution system.

FIGS. 5A and 5B depict a flowchart 500 of an example of a method for authenticating a station at an AP. This method and other methods are depicted as serially arranged modules. However, modules of the methods may be reordered, or arranged for parallel execution as appropriate. In the example of FIG. 5A, the flowchart 500 starts at module 502 where a message is received at an AP. The message may be in any form, including, by way of example but not limitation, a beacon frame.

In the example of FIG. 5A, the flowchart 500 continues to decision point 504 where it is determined whether the AP has a record of the bssid. In an illustrative embodiment, each AP includes a database of detected bssids. If a bssid is not represented in the detected bssid database, then a record should presumably be made for it.

If it is determined that the AP does not include a record of the bssid (504-N), then the flowchart 500 continues to module 506 where a record is made for the bssid, and the flowchart 500 continues to decision point 508 where it is determined whether the message includes a fingerprint. If it is determined that the message does not include a fingerprint (508-N), then the flowchart 500 continues to module 510 where the record is marked as spoofed. In an illustrative embodiment, each AP of a wireless domain includes a fingerprint in, e.g., beacon frames. Thus, if a beacon frame is received that does not include a fingerprint, it can be assumed that the beacon frame is not from an AP of the wireless domain.

In the example of FIG. 5A, after module 510 or if it is determined that the message includes a fingerprint (508-Y), the flowchart 500 continues to decision point 512 where it is determined whether to update the switch. Determining that a fingerprint exists in a message, such as a beacon frame, results in a bssid record being generated (and the fingerprint or a portion of the fingerprint recorded in association therewith). For this record, further authentication is unnecessary because it is not harmful to believe that the bssid and fingerprint are valid, since they are unique (i.e., they are apparently not spoofing attempts). Of course, if the same bssid is received later with a fingerprint, some additional implementation-specific verification may be desirable.

If it is determined that the switch is not to be updated (512-N), then the flowchart 500 continues to module 502 when a new message is received, and continues as described previously. If, on the other hand, it is determined that the switch is to be updated (512-Y), then the flowchart continues to module 514 where the switch is updated with relevant bssid records. Relevant bssid records may include, by way of example but not limitation, records marked as spoofed or records with a dirty bit set, signifying that the record has been changed since the last update to the switch. In the later case, the dirty bit would likely be reset around the time the switch is updated.

In the example of FIG. 5A, the flowchart 500 continues to module 515 where the switch or other distribution hardware verifies the field of the bssid record. In an illustrative embodiment, a switch verifies a fingerprint sent from the AP by computing a partial print. Using the terminology described by way of example but not limitation in association with FIG. 2, the switch may compute f(S[0], R[x], T2). In this example, the switch can compute S[0] from S[k], which can be derived from a fingerprinted message including S[k], R[x], and f(S[0], R[x], T2), obtain R[x] from the fingerprint, and obtain T2 from its own memory (since T2 is a shared secret that is known at the switch).

Returning once again to decision point 504, if it is determined that a record of the bssid exists (504-Y), then the flowchart 500 continues to decision point 516, where it is determined whether the message includes a fingerprint. If it is determined that the message does not include a fingerprint (516-N), then the flowchart 500 continues to module 510 and the flowchart 500 continues as described previously. If, on the other hand, it is determined that the message includes a fingerprint (516-Y), then the flowchart 500 continues to decision point 518 where it is determined whether the bssid in the message is used by the AP.

In an illustrative embodiment, each AP of a wireless domain includes a bssid database or some other data structure that includes a record of bssids. One or more of the records include bssids that are used by the AP. If, e.g., a beacon frame is received by the AP that includes one of its own bssids, that beacon frame is at least suspicious. If it is determined that the message includes a bssid that is used by the AP (518-Y), then the flowchart 500 continues to module 510 and the flowchart 500 continues as described previously. If, on the other hand, it is determined that the bssid is not being used by the AP (518-N), then the flowchart 500 continues to decision point 520 (see FIG. 5B).

In the example of FIG. 5B, at decision point 520, it is determined whether a reset number received in association with the message is equal to reset number recorded in association with the record of the bssid. If the received reset number is less than the recorded reset number (520-<), then the flowchart 500 continues to module 510 (FIG. 5A) where the record is marked as spoofed. This error (e.g., a beacon frame being received with a lower reset number than the recorded reset number) should not normally occur, but is included because it is, nevertheless, an error. So, if it occurs, it may, depending upon the implementation, be treated as a potential threat.

If, on the other hand, the received reset number and the recorded reset number are the same (520-=), then the flowchart 500 continues to decision point 522 where it is determined whether a partial print of the received message matches the partial print associated with the recorded bssid. The partial print may be, for example, a function of a sequence number, a reset number, and a portion of a shared secret. The partial print associated with the recorded bssid could be stored (e.g., calculated in advance, stored as is when received when the AP is being initialized, or stored as is when received in some other manner). Alternatively, the partial print could be recalculated each time it is needed. It may be more secure to store the partial print, rather than its component parts, though this is an implementation-specific decision.

If it is determined that the partial prints do not match (522-N), then the flowchart 500 continues to module 510 (FIG. 5A) where the record is marked as spoofed. The message is suspect because the partial fingerprint should be the same if the reset number has not changed (520-=), given that, in an illustrative embodiment, the partial fingerprint is computed from the reset number, a starting sequence number, and a shared public key. The starting sequence number and the shared public key are constant, and the reset number is unchanged. Accordingly, the stored partial print and the received partial print should match.

If, on the other hand, it is determined that the partial prints match (522-Y), then the flowchart 500 continues to decision point 524 where it is determined whether a sequence number received in association with the message follows a sequence number stored in association with the bssid record. For sequence numbers S[0], S[1], . . . , S[j], S[k], . . . , S[n], the recorded sequence number may be S[j]. Since the number is incremented for subsequent messages, the next expected sequence number from a message would be S[k]. S[k] may be referred to as following S[j].

If it is determined that the received sequence number does not follow the recorded sequence number (524-Y), then the flowchart 500 continues to module 510 (FIG. 5A) where the record is marked as spoofed. The message is suspect because sequence numbers are supposed to be incremented. If, on the other hand, it is determined that the received sequence number does follow the recorded sequence number (524-N), then the flowchart 500 continues to module 526 where a fingerprint is computed for the message. Referring back to decision point 520, if it is determined that the received reset number is greater than the recorded reset number (520->), then the flowchart 500 continues to module 526, as well.

In the example of FIG. 5B, in an illustrative embodiment, at module 526, a fingerprint is computed using (1) information sent in association with a message, and (2) a shared secret. Using the terminology introduced previously, the fingerprint may be, by way of example but not limitation, h(S[k], R[x], f(S[0], R[x], T2), T1). This value may be received as a secondary fingerprint in association with the message, where the other data provided in the message and the secondary fingerprint may be referred to collectively as the message's fingerprint. The values S[k], R[x], and f(S[0], R[x], T2) are received in association with the message, and the shared secret, T1, is known at the AP. Thus, the AP can compute the secondary fingerprint using (1) information sent in association with the message, and (2) the shared secret.

In the example of FIG. 5B, the flowchart 500 continues to decision point 528 where it is determined whether a fingerprint received in association with the message matches the computed fingerprint. If it is determined that the received fingerprint and the computer fingerprint do not match (528-N), then the flowchart 500 continues to module 530 where a record is updated to include the received fingerprint, and to module 510 (FIG. 5A) where the record is marked as spoofed, as described previously. If, on the other hand, it is determined that the received fingerprint and the computed fingerprint match (528-Y), then the flowchart 500 continues to module 532 where the bssid record is updated. For example, the record may be updated with a new sequence number and/or reset number. Advantageously, since any AP of a wireless domain can compute a fingerprint for any other AP that sends a message, using only data from the message and shared data, false positives of APs in the same wireless domain can be reduced or eliminated (see, e.g., FIG. 3).

Periodically or occasionally, an AP may update a switch or other distribution hardware with current bssid record values. This provides an additional level of security that may or may not be deemed necessary, depending upon the implementation. When records are updated at the AP (see, e.g., module 532), it may be desirable to set a “dirty bit” that can be used to indicate the record should be further verified at the switch or other distribution hardware. (The dirty bit may or may not also be set for records marked as spoofed.) Then, periodically or occasionally, the records marked spoofed and/or with a dirty bit set may be verified at the distribution hardware.

In the example of FIG. 5B, the flowchart 500 continues to decision point 534 where it is determined whether the bssid record is verified. If it is determined that the bssid record is verified (534-Y), then the flowchart 500 returns to module 502 (FIG. 5A) when a new message is received. If it is determined that the bssid record is not verified (534-N), then the flowchart 500 continues to module 536 where countermeasures are initiated and the flowchart 500 continues to module 502 (FIG. 5A) when a new message is received. Countermeasures may include any applicable known or convenient techniques for dealing with rogue or interfering devices. A relatively simple example of a countermeasure would be to inform the AP that the fingerprint is invalid, causing the AP to mark the bssid record as spoofed.

The techniques described herein are useful for the purpose of mitigating attacks on a wireless network. For example, the techniques can mitigate spoofing attacks, replay attacks, compromised sequence number or reset numbers, compromised access to AP codes, compromised APs, compromised switch codes, and compromised switch configurations. Specifically, making reference to the flowchart 500 (FIGS. 5A and 5B), for illustrative purposes only, a simple spoofing attack does not work because it does not have a fingerprint (508/516). A replay attack does not work because the attacker uses a used bssid (518) and/or has the wrong sequence number (524). If the attacker has an ability to compute S[k]+1 from S[k], or R[x]+1 from R[x], he still cannot generate a correct fingerprint due to lack of knowledge of h( ) and T2. If the attacker has knowledge of h( ), he cannot generate a valid fingerprint due to lack of knowledge of T2. If the attacker has knowledge of T2, he can still not generate an attack due to lack of knowledge of T1 and f( ). If the attacker has knowledge of f( ), he can still not generate an attack due to lack of knowledge of T, h( ). If the attacker has access to a wireless switch, he can retrieve T, and hence T1 and T2. He would still need knowledge of f( ), h( ) and other algorithms to launch an attack.

In an illustrative embodiment, a bit in the AP rfdetect records is set once a beacon is seen from that device. In absence of this bit set, if there is a wired disconnectivity, the AP will not be classified as rogue. The classification will continue to stay as interfering and a log message will be generated specifying the reason for not classifying the AP. The spoofed fingerprint message will also not be generated in this case.

It may be desirable to run experiments to find out how long it takes to do fingerprint verification on the AP. The actual functions used may be decided based on, for example, the results of this verification. It is believed that, using at least some verification techniques, an MD5 hash of 16 bytes on the received side can be computed on a per packet basis. Different functions may be used, depending upon factors such as whether an AP can, under operating conditions, perform the computation per beacon. Variations on the functions may be possible, depending upon the capabilities of the AP. By way of example but not limitation, two illustrative cases are given below, though it should be recognized that other applicable functions would fall within the scope of the teachings provided herein.

### A. Capable of MD5 Hash Computation of 16 Bytes for Every Beacon

1. R is a sequence that starts with R[1]=1 and increases monotonically as R[n]+1=R[n]+1. R is 2 bytes long.
2. S is a sequence that starts with S[0], such that S[0]=(2̂10)n, where n is a random number. S[k]=S[0]+k. S[n] is 4 bytes long.
3. T is a byte sequence that is 16 bytes long. T1 is the first 4 bytes of SHA(T), and T2 is the next 12 bytes of SHA(T). SHA is the SHA hash of T.
4. f( ) is computed from the 16 byte SHA-1 hash of S[0], R[n], T2. f( ) is 6 bytes and is computed as 6 bytes starting from offset i in the hash result, where i is the value of the first 7 bits.
5. h( ) is computed as MD5 hash of S[k], R[n], T1, f(S[0], R[n], T2)). h( ) is four bytes long, computed as (W1 XOR W2 XOR W3 XOR W4), where W1 is the ith uint in the hash.
6. The fingerprint is a concatenation of S[k], R[n], f( ) and h( ), and is 16 bytes long.

### B. Incapable of MD5 Hash Computation of 16 Bytes for Every Beacon

1. R is a sequence that starts with R[1]=1 and increases monotonically as R[n+1]=R[n]+1. R is 2 bytes long.
2. S is a sequence that starts with S[0], such that S[0]=(2̂10)n, where n is a random number. S[k+1] can be computed from S[k] as S[k+1]=S[0]+[(S[k]+2̂9−k) mod 2̂10]. S[0] can be computed from S[k] as S[0]=(2̂10)*(S[k]/2̂10) or (S[K] & 0xc00). S[n] is 4 bytes long.
3. T is a byte sequence that is 16 bytes long. T1 is the first 4 bytes of T, and T2 is the last 12 bytes of T.
4. f( ) is computed from the 16 byte MD5 hash of S[0], R[n], T2. f( ) is 6 bytes and is computed as ((W1̂W2)<<16)̂W3̂W4) where W1 is the ith uint in the MD5 hash result.
5. h( ) is computed as (S[k] XOR R[n] XOR k XOR T1 XOR f(S[0], R[n], T2)). h( ) is four bytes long.
6. The fingerprint is a concatenation of S[k], R[n], f( ) and h( ), and is 16 bytes long.

### C. Incapable of Implementing Algorithm B. 2. on a Per Packet Basis

1. Implement algorithm B. 1. with verification done once every n packets.

A specific configuration for a particular implementation involves setting rfdetect values. For example, the configuration may include setting an rfdetect signature key <key-value>, setting an rfdetect signature encrypted-key <key-value>, where <key-value> is a 16 byte byte string that is configured on all wireless switches in the mobility-domain. In absence of a key-value, the seed ip-address may be used as a key by padding the four octets of the IP address with zeroes. An IP address of A.B.C.D translates to A000-B000-C000-D000 as a key. The configuration may further include setting an rfdetect signature [enable|disable]. A command of this type may generate warning when an attempt to disable signature is made.

Another example of a specific configuration may include DTD changes. For example, the following DTD could be implemented:

<!ATTLIST RF-CONFIGURATION

| | |
|---|---|
| %XML-TXN-SUPPORTED; | “SET” |
| %ELEMENT-CONTAINER; | “RF-DETECTION” |
| %ELEMENT-KEY; | “_UNIQUE_::” |

| | Log | %YORN; | “YES” |
|---|---|---|---|
| | channel-scan | %YORN; | “YES” |
| | fingerprint | %YORN; | “YES” |
| + | key | CDATA | “” |
| | neighborlist-snr | %POS_INTEGER; | “12” |
| > | | | |

As used herein, a wireless network refers to any type of wireless network, including but not limited to a structured network or an ad hoc network. Data on a wireless network is often encrypted. However, data may also be sent in the clear, if desired. With encrypted data, a rogue device will have a difficult time learning any information (such as passwords, etc.) from clients before countermeasures are taken to deal with the rogue. The rogue may be able to confuse the client, and perhaps obtain some encrypted data, but the risk is minimal (even less than for some wired networks).

As used herein, access point (AP) refers to receiving points for any known or convenient wireless access technology. Specifically, the term AP is not intended to be limited to 802.11 APs.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and techniques described herein also relate to apparatus for performing the algorithms and techniques. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used herein, the term “message” means any applicable known or convenient data structure that can be provided from one location to another. For example, the data structure could be a frame, a packet, or multiples of frames and/or packets. The message may be embodied in a computer readable medium or on a carrier wave transmitted through any known or convenient medium. The message may intentionally provide information, or inadvertently, incidentally, or coincidentally provide information, to a recipient of the message.

As used herein, the term “basic service set identifier” (bssid) has a particular meaning in the art. That is, a bssid is at least associated with each AP. The “service set identifier,” on the other hand, is assigned to all of the APs of a network. It should be noted, however, that these terms are simply labels, and that, depending upon implementation details or technology, different terms may be used. Accordingly, with the intent to capture the general meaning of an identifier for an AP, the term AP identifier (AP ID) is used in the claims, and it should be understood that a wireless domain that includes the AP IDs is, in at least some embodiments and implementations, to have a name (i.e., the equivalent of an ssid).

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system comprising:
a wireless switch, including:
a shared secret, embodied in a computer-readable medium, including a public key and a private key;
a verification engine capable of generating a partial fingerprint using the private key;
an access point (AP) coupled to the wireless switch through a secure connection;
wherein, in operation:
after AP startup or reset, the AP sends a reset number to the wireless switch,
the verification engine computes a partial fingerprint from the reset number; a starting sequence number, and the public key;
the wireless switch sends the starting sequence number, the partial fingerprint, and the public key over the secure connection to the AP.

2. The system of claim 1, wherein the reset number has a value R[x], where R[x] is one of a sequence of monotonically increasing values, R[0], R[1], . . . R[x], R[y], . . . , R[n] that denote the reset count of the AP.

3. The system of claim 1, wherein the starting sequence number has a value S[0], where S[0] is a first of a sequence of values, S[0], S[1], . . . , S[j], S[k], . . . , S[n], wherein S[0] is easily determinable if S[k] is known, and wherein S[k] is easily computable if S[j] is known.

4. The system of claim 1, wherein the partial fingerprint is derived from a function, f( ), wherein f( ) is a one-way hash function that is difficult to reverse engineer in a reasonable time even after a large sample size for the output of f( ) is made available, and wherein f( ) is cannot reasonably be expected to be performed on a per-packet basis.

5. The system of claim 1, further comprising a plurality of wireless switches, including the wireless switch, wherein the shared secret is shared among the plurality of wireless switches.

6. The system of claim 1, wherein the AP is a first AP, further comprising:
a distribution system, including the wireless switch, for a wireless domain;
a second AP of the wireless domain;
wherein, in operation:
after AP startup or reset, the second AP sends a reset number to the distribution system,
the distribution system computes a partial fingerprint from the reset number; a starting sequence number, and the public key;
the distribution system sends the starting sequence number, the partial fingerprint, and the public key over a secure connection to the second AP.

7. The system of claim 1, further comprising a wired backbone to which the wireless switch is coupled.

8. The system of claim 1, wherein the AP is a first AP, further comprising:
a second AP;
an AP identifier (AP ID) database, embodied in a computer-readable medium at the first AP, including records having fields;
an authentication engine embodied in a computer-readable medium at the first AP;
wherein, in operation:
the second AP broadcasts a message including an AP ID and first data;
the first AP receives the message including the AP ID and first data;
the authentication engine computes a fingerprint using the first data and second data;
the authentication engine compares the computed fingerprint to a record in the AP ID database having a first field that includes the AP ID, and a second field that includes a recorded fingerprint;
the authentication engine determines that the first AP and the second AP are in a same wireless domain if the computer fingerprint and the recorded fingerprint match.

9. The system of claim 8, wherein the reset number is a first reset number and the partial fingerprint is a first partial fingerprint, wherein the first data includes a second reset number, a sequence number, a second partial fingerprint, and a secondary fingerprint.

10. The system of claim 8, wherein the second data includes the public key.

11. The system of claim 8, wherein the AP ID database is a bssid database, and the AP ID includes a bssid.

12. A system comprising:
a means for sharing a shared secret, including a public key, at a distribution system associated with a wireless domain;
a means for initializing an access point (AP) of the wireless domain, including:
receiving a reset number from the AP;
providing a starting sequence number, a partial fingerprint, and a public key to the AP;
a means for authenticating a station at the AP, including:
receiving a bssid and a fingerprint from the station;
computing a fingerprint from the received fingerprint and the public key;
determining whether the computed fingerprint matches the received fingerprint;
updating a record associated with the bssid if the computed fingerprint and the received fingerprint match.

13. A method comprising:
receiving a message having a bssid and a fingerprint;
computing a fingerprint from the received fingerprint and known data;
determining whether the computed fingerprint matches the received fingerprint;
updating a record associated with the bssid if the computed fingerprint and the received fingerprint match.

14. The method of claim 13, further comprising:
determining whether a record of the bssid is available;
creating a record for the bssid if a record of the bssid is not-available.

15. The method of claim 13, further comprising:
determining whether a record of the bssid indicates the bssid is being used;
marking the record as spoofed if the bssid is being used.

16. The method of claim 13, wherein the message includes a reset number further comprising:
determining that a received reset number is greater than a recorded reset number, wherein the received reset number is received in association with the message and the recorded reset number is recorded in association with a recorded bssid that matches the bssid of the message.

17. The method of claim 13, further comprising:
determining whether a received reset number matches a recorded reset number, wherein the received reset number is received in association with the message and the recorded reset number is recorded in association with a recorded bssid that matches the bssid of the message.
if the received reset number matches the recorded reset number:
determining whether a received partial print matches a recorded partial print;
marking the record as spoofed if the received partial print and the recorded partial print do not match.

18. The method of claim 13, further comprising:
determining whether a received reset number matches a recorded reset number, wherein the received reset number is received in association with the message and the recorded reset number is recorded in association with a recorded bssid that matches the bssid of the message.
if the received reset number matches the recorded reset number:
determining whether a received sequence number follows a recorded sequence number;
marking the record as spoofed if the received sequence number does not follow the recorded sequence number.

19. The method of claim 13, further comprising, if the computed fingerprint and the received fingerprint are different:
updating a record associated with the bssid with the computed fingerprint;
marking the record as spoofed.

20. The method of claim 13, further comprising:
updating a distribution system with relevant bssid records;
verifying the bssid records at the distribution system.
